(19) United States
(12) Patent Application Publication
(10) Pub. No.: US 2019/0010993 A1
(43) Pub. Date: Jan. 10, 2019

(54) FRICTION DISC

(71) Applicant: Miba Frictec GmbH, Laakirchen (AT)

(72) Inventor: Martin LIEBL, Laakirchen (AT)

(73) Assignee: Miba Frictec GmbH, Laakirchen (AT)

(21) Appl. No.: 16/025,260

(22) Filed: Jul. 2, 2018

(30) Foreign Application Priority Data
Jul. 7, 2017 (AT) A 50564/2017

(51) Int. Cl. F16D 13/68

(52) U.S. Cl. CPC F16D 13/686

(57) ABSTRACT

The invention relates to a friction disc (10) with a disc body (5, 9) which has at least one vibration damping element (13), which consists of at least one elastomer or comprises the latter.

The invention relates to a friction disc with a disc body which has at least one vibration damping element, and on which, if applicable, at least one friction lining is arranged.

The invention further relates to a disc set comprising several friction discs arranged one behind the other in an axial direction.

Vibration-damped clutches are already known from the prior art in the most varied of embodiments. For example, DE 32 673 A1 describes a torsional vibration damper for vehicle friction clutches, in which the torque transmission from the primary part, embodied in a shaft-like manner, to the approximately drum-like secondary part carried by it, takes place via an annular clutch body arranged therein, which engages into the primary part with a thrust device permitting longitudinal displacements and is displaceably connected to the periphery of the secondary part by an axial toothing, wherein on both sides of the clutch body in each case a plate spring is situated, which rests against the wall of the secondary part. The chambers of the springs on both sides are filled with damping oil which, on stressing through a throttle duct situated in the clutch body, can flow over from one chamber into the other. A disadvantage here is that with each rotation direction always only one plate spring is in action, whilst the other remains uninvolved. In addition, installation space must be additionally made available for the hydraulic damping.

Clutch discs with torsion springs are also known.

The present invention is based on the problem of providing a friction disc or respectively a friction disc set with simple vibration damping.

This problem is solved in the friction disc mentioned in the introduction in that the vibration damping element consists of at least one elastomer, or comprises the latter. In addition, the problem is solved with the above-mentioned disc set, which has the friction disc according to the invention.

It is advantageous here that through the vibration damping element consisting of an elastomer or respectively comprising the latter, the vibration damping of the friction disc can be adapted more simply, because the elastomer can be placed more easily at any location of the friction disc. In addition, this vibration damping element can be connected more easily to the disc body. It is therefore possible in a simple manner to alter the natural frequency of the friction disc. Therefore, friction vibrations can be reduced and torque peaks in the torque transmission in the disc set can be damped. Through the arrangement of the vibration damping element directly on the friction disc, the vibration behaviour of the friction disc per se can be influenced. It is possible here to equip friction discs of a disc set with different vibration damping elements, whereby the vibration behaviour of the disc set can be influenced more precisely. Furthermore, the vibration damping element can be constructed simply. The integration of the vibration damping element into the friction disc can thereby be simplified.

According to a variant embodiment of the friction disc, provision can be made that the disc body has several parts and that the vibration damping element is arranged between the parts of the disc body. It is thereby possible to transmit the torque via the vibration damping element, whereby the vibration damping can be configured more efficiently.

According to a variant embodiment in addition the disc body can have at least one hub part and a friction lining carrier part, wherein the vibration damping element is arranged at least partly between the hub part and the friction lining carrier part. Thereby, despite vibration damping, the axial overall length of the friction disc, and thereby of the disc set, can be reduced. In addition, the hub part can thereby be produced with greater precision, for example by fine stamping, whereby punched retraction and tears can be reduced and thereby a greater percentage contact area can be realized in the carrier elements of an inner disc. It is thereby possible to embody the friction disc so as to be thinner. In addition, it is thereby also possible to define “standard grains” which can be used in several different friction discs.

According to another variant embodiment of the friction disc, provision can be made that the hub part is connected to the friction lining carrier part via the vibration damping element, whereby the structure of the friction disc can be simplified by the elimination of an additional connecting means.

Provision can also be made that the disc body has disc body segments, and that the vibration damping element is arranged at least partly between the disc body segments. Thereby, in a simple manner (additionally) a radial vibration damping can be achieved. In addition, through the segmenting of the disc body, a saving on raw material is able to be achieved, because more segments than entire rings can be manufactured from a raw material blank of the same size.

The disc body can have at least one recess in which the vibration damping element is at least partly arranged. Thereby, a better connection of the vibration damping element to the disc body is able to be achieved.

In addition, the vibration damping element can have a recess and at least a portion of the disc body can have at least one axial projection, wherein the axial projection is arranged extending into the recess of the vibration damping element. With this variant embodiment, an additional form-fitting connection of the vibration damping element is able to be achieved, whereby the load-carrying capacity of the vibration damping element can be increased or respectively the risk of the tearing off of the vibration damping element can be reduced.

In addition, it is possible that the disc body has a carrier element, wherein the vibration damping element is arranged on the carrier element. Thereby, a vibration damping can already be achieved on the introduction of the torque into the friction disc, because a direct metal-to-metal contact between the friction disc and the disc support is prevented.

According to a variant embodiment of the disc set, provision can be made that several friction discs are connected to one another via at least one vibration damping element. The inner discs are constructed in an offset manner and are connected by the rods made of elastomer. Thereby, the additional effect to the vibration damping can be achieved, that the blade body of the friction disc consists of individual segments which are not connected to one another, wherein via the elastomer rods the segments are prevented from detaching themselves from the shaft due to centrifugal force and the radial reaction force (friction moment).

According to a further variant embodiment of the disc set, provision can be made that several friction discs have disc body segments and that the disc body segments of the friction discs, which are arranged one behind the other in the axial direction, are arranged offset in a circumferential direction. Through the prevention of the aligned impacts between the segments in the axial direction, a further influencing of the vibration behaviour of the disc set can be achieved.

For a better understanding of the invention, the latter is explained in further detail by means of the following figures.

These show respectively in simplified, diagrammatic representation:

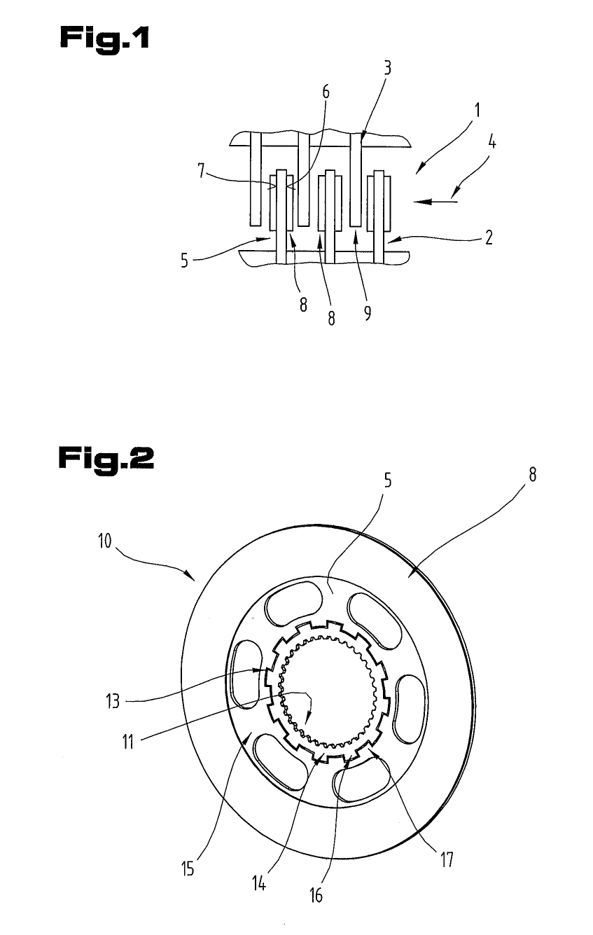

FIG. 1 a detail of a disc set in side view;

FIG. 2 a first variant embodiment of a friction disc in oblique view;

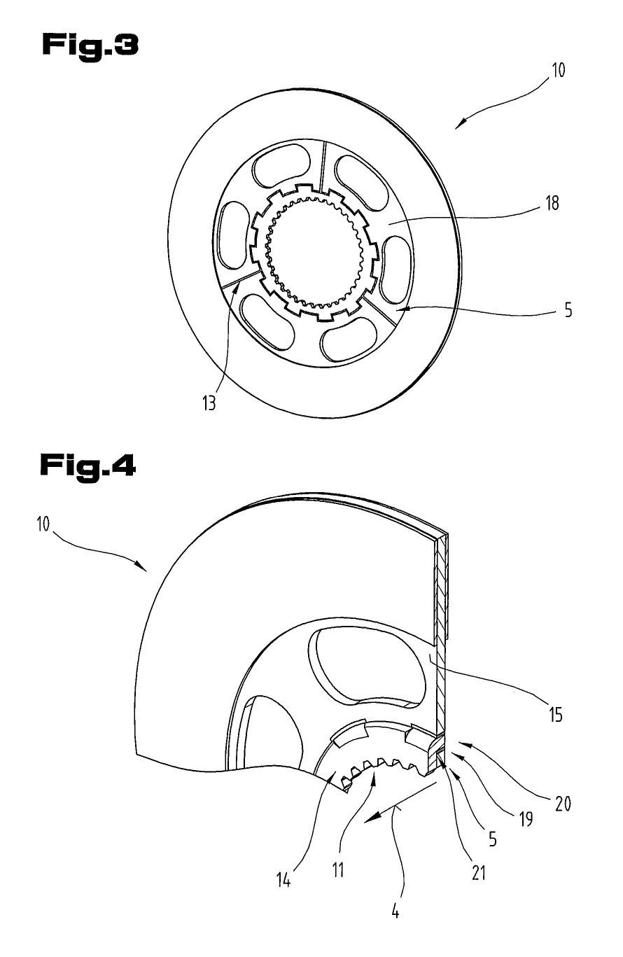

FIG. 3 a second variant embodiment of a friction disc in oblique view;

FIG. 4 a detail of a third variant embodiment of a friction disc in cross-section and in oblique view;

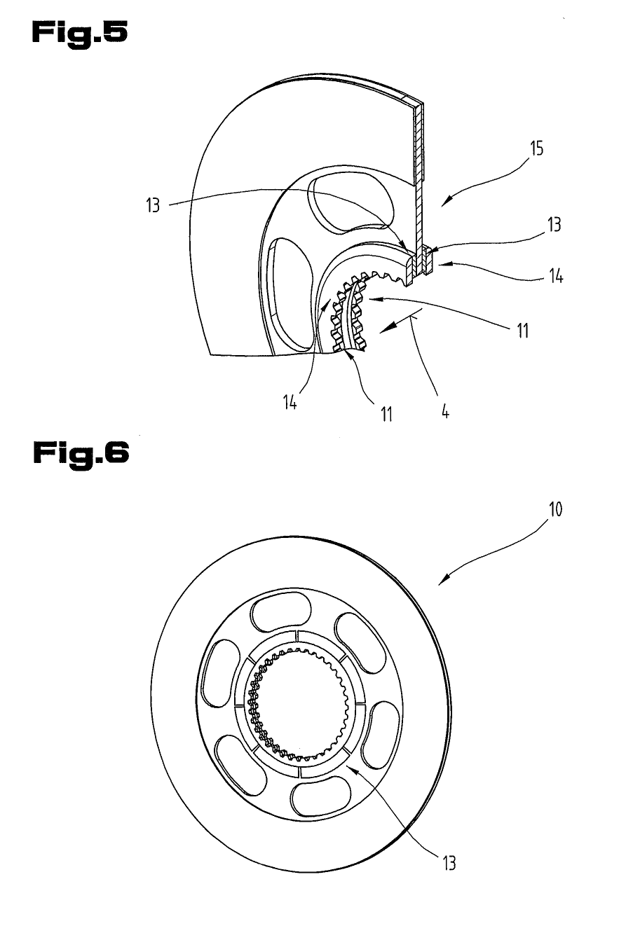

FIG. 5 a detail of a fourth variant embodiment of a friction disc in cross-section and in oblique view;

FIG. 6 a detail of the variant embodiment of the friction disc according to FIG. 5 in oblique view;

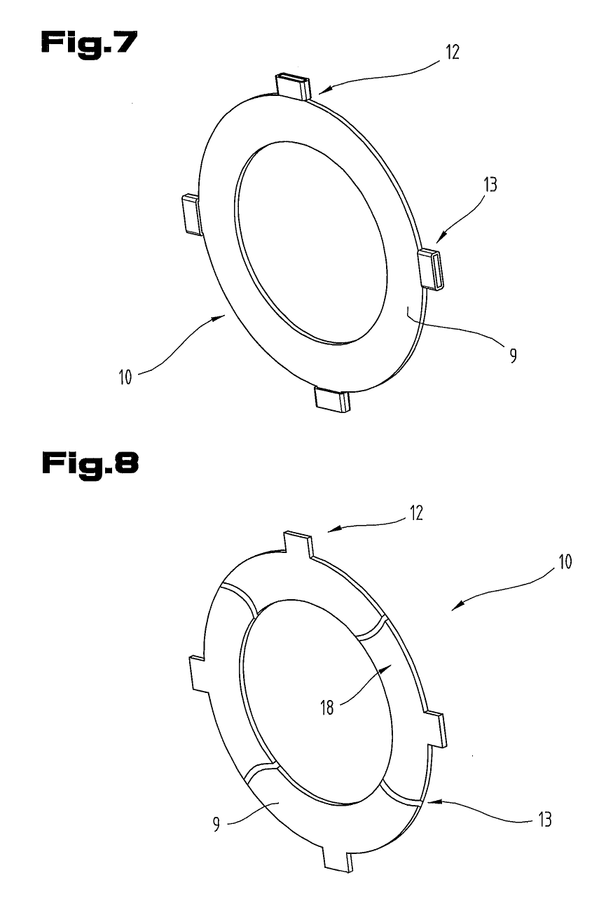

FIG. 7 a fifth variant embodiment of a friction disc in oblique view;

FIG. 8 a sixth variant embodiment of a friction disc in oblique view;

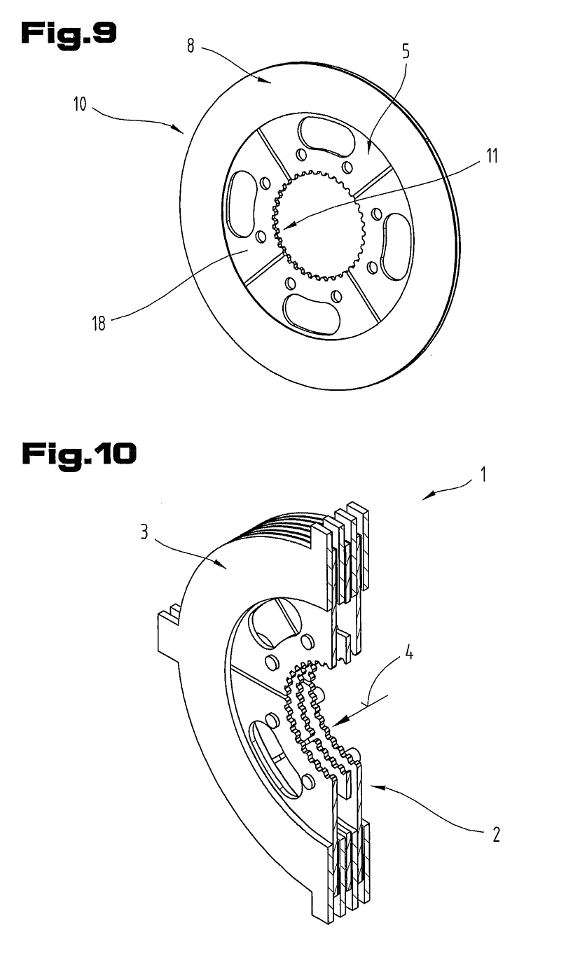

FIG. 9 a seventh variant embodiment of a friction disc in oblique view;

FIG. 10 a detail of a disc set in cross-section and in oblique view;

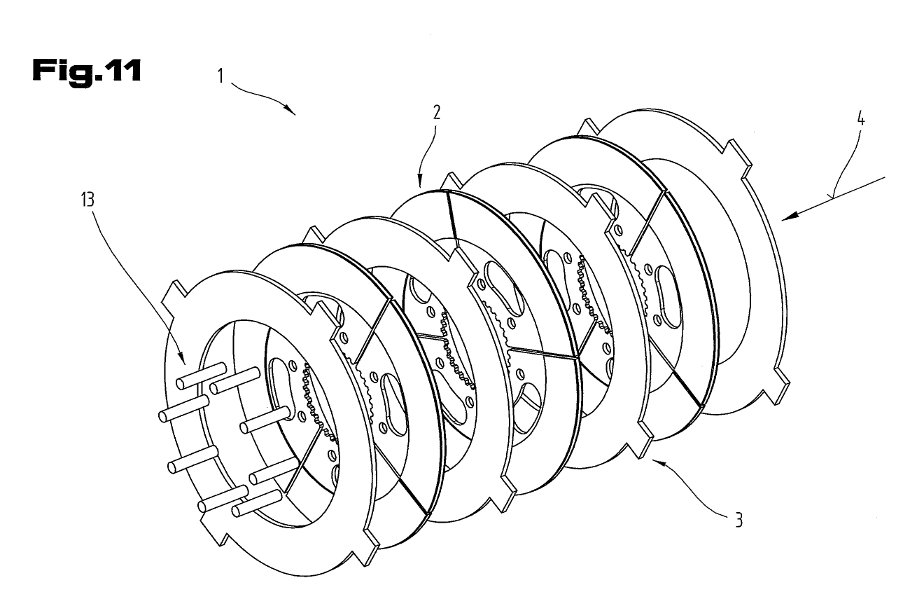

FIG. 11 an exploded illustration of a further variant embodiment of the disc set in oblique view.

In introduction, it is to be stated that in the variously described embodiments, identical parts are given the same reference numbers or respectively the same component designations, wherein the disclosures contained in the entire description can be transferred correspondingly to identical parts with identical reference numbers or respectively identical component designations. Also, the chosen positioning information in the description, such as e.g. above, below, lateral etc., refer to the immediately described and illustrated figure and are to be transferred, in the case of a change in position, correspondingly to the new position.

In FIG. 1 a detail of a disc set 1 is illustrated. The disc set 1 has several inner discs 2 and several outer discs 3, which can also be designated as friction discs. The inner discs 2 are arranged alternately with the outer discs 3 in an axial direction 4. Via a corresponding actuating mechanism, the inner discs 2 are displaceable relative to the outer discs 3 in the axial direction 4, so that a frictional engagement is formed between the inner discs 2 and the outer discs 3.

The inner discs 2 have an at least approximately ring-shaped disc body 5 with a first surface 6 and with a second surface 7 lying opposite the latter in the axial direction 4. On the first and/or second surface 6, 7 respectively at least one friction lining 8 is arranged. The inner discs 2 are therefore so-called lining discs.

The friction linings 8 can be embodied in accordance with the prior art.

Provision can also be made that the inner discs 2 have no friction linings 8.

The outer discs 3 also have an at least approximately ring-shaped disc body 9 which, however, is free of friction linings. The outer discs 3 are therefore the so-called counter-discs which can be brought into frictional engagement with the friction linings 8 of the inner discs 2.

However, it is also possible that friction linings 8 are arranged on the outer discs 3, in particular if no friction linings are arranged on the inner discs 2.

Preferably, the inner discs 2 and the outer discs 3 are produced from a steel. However, they may also be produced from another suitable, in particular metallic, material. For example, the inner discs can consist of a resin-bonded composite material or of a sintered material. The friction linings 8 arranged on the inner discs can consist, for example, of a carbon material or of a resin-bonded, if applicable fibre-reinforced, paper lining or of a resin-bonded lining or of a sintered material. Such friction linings are known from the prior art, so that reference is to be made thereto. It is also possible that the friction linings 8 are arranged on a support. The support preferably consists of steel or of another suitable material.

This basic structure of a disc set 1 is known from the prior art. For further details in this regard, reference is therefore to be made to this appropriate prior art.

The disc set 1 is part of a disc friction system, for example of a (wet-running) multiple disc clutch, a brake, a holding device, a differential block, etc.

In FIG. 2 a first variant embodiment of a friction disc 10 is illustrated, as is used in the disc set 1 according to FIG. 1. In particular, an inner disc 2 according to the illustration in FIG. 1 is shown. The friction disc 10 can, however, also be an outer disc 3 (FIG. 1), wherein in this case it preferably has no friction lining 8.

The friction disc 10 can have at least one carrier element 11, for example in the form of an inner toothing, on a radially inner face surface.

At this point it is to be mentioned that a friction disc 10 in the form of an outer disc 3 (FIG. 1) can have at least one carrier element 12 on a radially outer face surface, as is shown for example in FIG. 7.

Via the carrier elements 11 or 12, a torque-proof connection can be produced with a further component of the disc friction system, for example with a shaft in the case of the inner discs 2 or with the housing of the disc friction system in the case of the outer discs 3, as is known per se.

It is also possible that the inner discs 2 or the outer discs 3 are therefore embodied as so-called free-floating discs, therefore have no such carrier elements 11, 12.

On the disc body 5 (disc body 9 in the case of the outer disc 3) of the friction disc 10, at least one vibration damping element 13 is arranged. The vibration damping element 13 consists of at least one elastomer or comprises the latter. This applies accordingly to all variant embodiments of the friction disc 10 or respectively of the disc set 1.

The term elastomer is used according to the generally known classification of plastics.

The elastomer can be, for example, a natural rubber, a (carboxylated) nitrile-butadiene rubber, an isoprene rubber, a silicone elastomer. However, it is also possible that two or more different elastomers are used, which are connected to one another if applicable, in order to thereby influence the damping behaviour of the vibration damping element 13.

In addition, it is possible that the elastomer is reinforced, in particular fibre-reinforced. As fibres, natural or synthetic fibres can be used. The fibres can have a length of between 1 mm and 10 mm. The fibre content on the vibration damping element 13 can be between 0% by weight and 25% by weight. The at least one elastomer forms the remainder to 100%.

As can be seen from the figures, the friction disc 10 can consist exclusively of the disc body 5, 9, at least one vibration damping element 13 and, if applicable, at least one friction lining 8.

In the variant embodiment of the friction disc 10 according to FIG. 2, the disc body 5 has several parts. In particular, the disc body 5 consists of a hub part 14 and of a friction lining carrier part 15, or respectively has these parts. The vibration damping element 13 is arranged at least partly, in particular entirely, between the hub part 14 and the friction lining carrier part 15, so that therefore the friction lining carrier part 15 the radially outermost part, and the hub part 14 the radially innermost part, which is arranged in radial direction beneath the friction lining carrier part 15 and immediately radially beneath the vibration damping element 13. Both the hub part and also the friction lining carrier part 15 are embodied respectively at least approximately in a ring-shaped manner.

The friction lining(s) 8—several friction linings can also be arranged on the friction disc 10, for example one each per surface 6, 7 or several friction lining segments per surface 6, 7—is or are arranged exclusively on the friction lining carrier part 15 and are connected therewith.

Preferably, the hub part 14 is connected to the friction lining carrier part 15 exclusively by the at least one vibration damping element 13. For this, the at least one vibration damping element 13 can be e.g. vulcanized onto the hub part 14 and onto the friction lining carrier part 15.

In the simplest variant embodiment of this friction disc 10, the vibration damping element 13 can be embodied in the shape of a circular ring. However, it is also possible that—as illustrated in FIG. 2—the hub part 14 has on its radially outer circumference at least one radially outwardly protruding radial projection 16, and the friction lining carrier part 15 on its radially inner circumference has accordingly at least one radially inwardly protruding radial projection 17. The hub part 14 can be embodied for example on its radially outer circumference with a toothing. Accordingly, the friction lining carrier part 15 can have on its inner circumference the toothing which is complementary thereto, so that therefore the teeth of the friction lining carrier part 15 engage into the gaps between the teeth of the toothing of the hub part 14, and vice versa. Here, however, the at least one vibration damping element 13 is arranged between these two parts, as was already described and is shown in FIG. 2.

The teeth of the toothings can, as shown in FIG. 2, be embodied so as to be at least approximately rectangular (in view in the axial direction 4). However, other geometries are also possible, for example a square, a trapezoidal, an at least approximately triangular etc. geometry. In addition, instead of a toothing, also only one or several, for example only two, three, four, etc. radial projections 16, 17 can be arranged, which in this case are arranged preferably symmetrically distributed over the circumferences of the hub part 14 or respectively of the friction lining carrier part 15.

Preferably, however, no acute geometries are used, in order to prevent damage to the at least one vibration damping element 13. For this reason preferably also the edges of the hub part 14 and/or of the friction lining carrier part 15 can be embodied so as to be chamfered or rounded at least in the region of the abutting of the vibration damping element 13.

The at least one vibration damping element 13 can be embodied flush with the hub part 14 and with the friction lining carrier part 15. However, it is also possible that the at least one vibration damping element 13 is embodied overlapping at least one of the surfaces 6, 7 (FIG. 1) radially below and/or radially above in the axial direction 4. For example, the at least one vibration damping element can therefore have an H-shaped or a U-shaped cross-section (viewed in the circumferential direction of the friction disc 10).

The vibration damping element 13 can be embodied in one piece, i.e. running uninterruptedly in circumferential direction of the friction disc 10, as is illustrated in FIG. 2. However, it is also possible that the vibration damping element 13 is embodied in a segmented manner, wherein the segments are arranged spaced apart from one another in circumferential direction of the friction disc 10. In other words, in this variant embodiment, the entire intermediate space—viewed over the circumference between the hub part 14 and the friction lining carrier part 15 is therefore not filled with the at least one elastomer.

At this point, it is to be pointed out once again that the statements concerning the friction disc 10 can be applied both to an inner disc 2 and also to an outer disc 3 (FIG. 1), even if corresponding adaptations are necessary for this, following the geometry of the respective friction disc 10, for example with regard to the carrier elements 11, 12, which are naturally positioned differently on the inner disc 2 than on the outer disc 3.

The friction lining carrier part 15 can be embodied to be of the same thickness as, or thinner than, the hub part 14. Thinner, because the thickness of the friction lining carrier part 15 is independent of the surface pressure on the carrier elements 11 of the hub part 14. However, it is also possible that the friction lining carrier part 14 is embodied to be thicker than the hub part 14.

In FIGS. 3 to 11, further and, if applicable independent per se, variant embodiments of the friction disc 10 or respectively of the disc set 1 are shown, wherein again the same reference numbers or respectively component designations are used for identical parts as in the preceding FIGS. 1 and 2. In order to avoid unnecessary repetitions, the detailed description regarding FIGS. 1 and 2 is to be referred to or respectively reference is to be made thereto.

The variant embodiment of the friction disc 10 according to FIG. 3 is similar to that according to FIG. 2. In the variant embodiment according to FIG. 3, however, the disc body 5 has disc body segments 18, i.e. the disc body is embodied so as to be segmented. In the practical variant embodiment of the friction disc 10, only the friction lining carrier part 15 is embodied in a segmented manner, the hub part 14, is still embodied as a single, ring-shaped component. However, the possibility also exists that additionally or alternatively to the segmented friction lining carrier part 15, the hub part 14 is also embodied in a segmented manner.

In FIG. 3, three segments are illustrated. This number is, however, not to be understood as being limiting. Also, only two or more than three, for example four or five or six etc. segments can be arranged.

The disc body segments 18 are arranged spaced apart from one another in circumferential direction of the friction disc 10. The intermediate space thereby arising between the segments is filled at least partly, in particular entirely, with the elastomer of the vibration damping element 13, whereby an additional vibration damping can be achieved. The elastomer can be identical to or different from the elastomer which is used between the hub part 14 and the friction lining carrier part 15.

Face surfaces of the disc body segments 18 pointing in circumferential direction of the friction disc 10 can be embodied so as to be planar and running at least approximately in radial direction, as is illustrated in FIG. 3.

However, it is also possible that in the region of these face surfaces—in an analogous manner to, or respectively in the manner of the formation of the face surfaces of the hub part 14 and of the friction lining carrier part 15 pointing towards each other—form-fitting elements are formed. The form-fitting elements can be embodied for example at least approximately in a rectangular or square shape or in the manner of a toothing. Thereby, inter alia, the volume fraction of elastomer between the disc body segments 18 can be increased.

For further details of the friction disc 10, reference is to be made to the statements concerning FIG. 2.

According to another variant embodiment of the friction disc 10, provision can be made that the disc body 5 has at least one recess 19 or respectively aperture in the axial direction 4, in which the vibration damping element 13 is at least partially or entirely arranged. A possible variant embodiment to this is illustrated in FIG. 4. Here, the friction lining carrier part 15 has several such recesses or respectively apertures distributed, in particular uniformly distributed, in circumferential direction.

According to a further variant embodiment of the friction disc 10, provision can be made here that the vibration damping element 13 also has a recess 20, and that in addition at least a part of the disc body 5, in particular the hub part 14, has at least one axial projection 21, and that the axial projection 21 is arranged extending into the recess of the vibration damping element 13, as is also illustrated in FIG. 4. Here, each of the vibration damping elements can have such a recess 20 or respectively an aperture in the axial direction 4, or only a portion thereof. In addition, in each of these recesses 20 or in only in a portion thereof respectively an axial projection 21 can be arranged.

Preferably, the at least one recess 20 is filled entirely with the axial projection 21. In addition, the recess 19 in the disc body is preferably filled entirely with the vibration damping element 13 (and, if applicable, with the axial projection 21 arranged in the latter).

Unlike in the variant embodiments of the friction disc 10 according to FIGS. 2 and 3, the hub part 14 in the variant embodiment is no longer arranged entirely and immediately radially beneath the friction lining carrier part 15. Rather, the hub part 14 is arranged offset in the axial direction 4 with respect to the friction lining carrier part 15 and lying against the latter or respectively connected with the latter (at least via the at least one axial projection 21). Provision can also be made here that the hub part 14 is glued to the friction lining carrier part 15 in regions adjacent to the at least one recess 20 in the friction lining carrier part 15.

In any case, however, the carrier elements 11 of the hub part 14 protrude in radial direction downwards over the friction lining carrier part 15.

The at least one axial projection 21 can be produced for example by the bending of a correspondingly formed tongue of the hub part 14.

Unlike in the variant embodiments of the friction disc 10 according to FIGS. 2 and 3, the radially outer face surfaces of the hub part 14 and/or the radially inner face surface of the friction lining carrier part 15 can be embodied as cylinder surfaces (in the case of the hub part 14 at least adjacent to the bent axial projections 21). Therefore, no radial projections 16 or respectively 17 may be present.

With regard to further details of the friction disc 10, such as for example the axially overlapping geometry of the vibration damping element 13 or the rounded edges, reference is to be made to the statements concerning FIG. 2.

Also in the variant embodiment of the friction disc 10 according to FIGS. 5 and 6, the hub part 14 is arranged laterally in the axial direction 4 with respect to the friction lining carrier part 15. In contrast to the variant embodiment shown in FIG. 4, however, a hub part 14 is arranged on both sides of the friction lining carrier part 15, so that therefore the friction lining carrier part 14 is arranged in the axial direction 4 between the two hub parts 14. However, it is pointed out that such a configuration is also possible in the variant embodiment of the friction disc 10 according to FIG. 4, wherein in this case the axial projections of the two hub parts 14 are embodied in an offset manner in circumferential direction of the friction disc 10.

The connection between the two hub parts 14 and the friction lining carrier part 15 takes place again directly via the at least one vibration damping element 13, wherein in this variant embodiment respectively at least one vibration damping element 13 is arranged on both sides of the friction lining carrier part 15. However, the possibility also exists for the arrangement of several vibration damping elements 13 per side, as is illustrated in FIG. 6, in which the illustration of the second hub part 14 was dispensed with, in order to have a view onto the several vibration damping elements 13.

The carrier elements 11 of the two hub parts 14 can be arranged aligned with one another in the axial direction 4. However, the possibility also exists that the two hub parts 14, on connecting with the friction lining carrier part 15, are prestressed with respect to one another via the at least one vibration damping element 13, therefore the carrier elements 11 are no longer aligned with one another in the axial direction 4. Thereby, a play, for example the tooth flank play, if the carrier elements 11 are embodied as toothings, can be compensated between the friction disc 10 and the above-mentioned shaft carrying the latter.

FIGS. 7 and 8 show embodiments of the friction disc 10 as outer disc 3 (FIG. 2), in order to thereby clarify once again that the friction disc 10 may not only be an inner disc 2, as is the case in the variant embodiments described above.

The disc body 9 friction disc 10 according to FIG. 7 is embodied in one piece. On the outer circumference, the carrier elements 12 are arranged projecting radially outwards. Provision is now made that the vibration damping element 13 is arranged on at last one of the carrier elements 12, preferably from all carrier elements 12 a vibration damping element 13 is arranged. Provision can be made here that vibration damping element 13 surrounds the carrier element 12 over the entire circumference, as is illustrated in FIG. 7. However, a vibration damping element 13 can also be arranged (respectively) only on one or more of the circumferential areas.

In the variant embodiment of the friction disc 10 according to FIG. 8, the carrier elements 12 are free of vibration damping elements 13. Instead, the disc body 9 is embodied in a segmented manner with the disc body segments 18. The illustrated number of disc body segments 18 is, again, not to be understood as being restrictive.

The disc body segments 18 are arranged spaced apart from one another in the circumferential direction with the formation of an intermediate space. The intermediate spaces are filled at least partly, in particular entirely, with vibration damping elements 13, whereby the disc body segments 18 are connected to one another.

With regard to further details of the friction disc 10, such as for example the axially overlapping geometry of the vibration damping element 13 or the rounded edges or the shape of the face surfaces of the disc body segments 18, pointing in circumferential direction (which are illustrated running in a round manner in FIG. 8), reference is to be made to the above statements, in particular those concerning FIG. 2.

It is to be pointed out in addition that combinations of the friction disc 10 according to FIGS. 7 and 9 are also possible.

The variant embodiment of the friction disc 10 according to FIG. 9 (again embodied as inner disc 2 (FIG. 1)), is also embodied having several parts. However, the multipart state of the disc body 5 with [is] not achieved by its division into a friction lining carrier body 15 and at least one hub part 14, as was described above, but rather exclusively through the division of the disc body 5 into several disc body segments 18. The vibration damping elements 13 are arranged, again, between the disc body segments 18 and connect these with each other.

In addition, the friction lining 8 can be embodied as a single ring and therefore continuous in the circumferential direction, as is illustrated, or it can also be embodied in the form of segments, wherein in this case the segments preferably do not overlap the vibration damping elements 13, even though this is possible.

The friction disc 10 can also be formed on both sides with at least one friction lining 8.

In this variant embodiment of the friction disc 10 or respectively in all variant embodiments of the friction disc 10, in which the carrier elements 11 are divided to several disc body segments 18, provision can also be made that for compensating a play between the carrier elements 11 and the shaft carrying the friction disc 10, which shaft likewise has a corresponding surface form, the disc body segments 18, prestressed with respect to one another, are connected to the elastomer of the vibration damping elements 13, as was already described above.

With regard to further details of the friction disc 10, such as for example the axially overlapping geometry of the vibration damping element 13 or the rounded edges or the shape of the face surfaces of the disc body segments 18, pointing in circumferential direction, reference is to be made to the above statements, in particular those concerning FIG. 2.

Variant embodiments of the disc set 1 are illustrated in FIGS. 10 and 11.

Here, according to a variant embodiment, provision can be made that several friction discs 10 are connected to one another via at least one vibration damping element 13.

The at least one vibration damping element 13—preferably several vibration damping elements 13 are used, for example between two and twenty—is embodied in particular in a rod-shaped manner with a longitudinal extent in the direction of the axial direction 4. Although the at least one vibration damping element 13 in FIGS. 10 and 11 is illustrated as a round rod, this can also have different cross-sectional shapes, for example an oval, a square, a rectangular etc. shape.

In so far as several rod-shaped vibration damping elements are used, these are preferably arranged distributed symmetrically in circumferential direction of the friction disc 10.

In the illustrated variant embodiment of the disc set 1, exclusively several, in particular all, inner discs 2 of the disc set are connected with one another with the at least one vibration damping element 13. However, it is also possible that therewith exclusively several, in particular all, outer discs 3 of the disc set 1 are connected with one another.

For connecting the friction discs 10 via the at least one vibration damping element 13, the friction discs have apertures in the axial direction 4, through which the at least one vibration damping element projects. The apertures are embodied aligned with one another in the axial direction 4.

In FIGS. 10 and 11 a further variant embodiment of the disc set 1 is illustrated, in which several friction discs have the disc body segments 18. The disc body segments of the friction discs 10, arranged one behind the other, are arranged offset in the circumferential direction of the friction discs. Within a friction disc 10, [they] are arranged spaced apart from one another in circumferential direction. In so far as the disc body segments 18 of a friction disc 10 are not connected to one another via vibration damping elements 13 arranged in intermediate spaces occurring through the spacing, the disc body segments of several, in particular all, inner discs 2 or outer discs 3 can be connected exclusively via the described rod-shaped vibration damping elements 13. In this case, the intermediate spaces can remain free.

The vibration damping element 13 or the vibration damping elements 13 can also consist at least partly or entirely of a material other than an elastomer, such as for example a metal or a metal alloy. In this case, a material is used which has a different E-modulus from the disc body 5 (in the case of an outer disc 3 disc body 9), in particular a lower E-modulus, respectively observed at 20° C. The example embodiments show possible variant embodiments of the disc set 1 or respectively of the friction disc 10, wherein it is noted at this point that various combinations with one another of the individual variant embodiments shown in FIGS. 2 to 11 are possible.

For the sake of good order, it is pointed out in conclusion that for a better understanding of the structure of the disc set 1 or respectively of the friction disc 1, these are not necessarily illustrated to scale.

### LIST OF REFERENCE NUMBERS

1 disc set
2 inner disc
3 outer disc
4 axial direction
5 disc body
6 surface
7 surface
8 friction lining
9 disc body
10 friction disc
11 carrier element
12 carrier element
13 vibration damping element
14 hub part
15 friction lining carrier part
16 radial projection
17 radial projection
18 disc body segment
19 recess
20 recess
21 axial projection

1. A friction disc (10) with a disc body (5, 9) which has at least one vibration damping element (13), and on which if applicable at least one friction lining (8) is arranged, wherein the vibration damping element (13) comprises at least one elastomer or comprises the latter.

2. The friction disc (10) according to claim 1, wherein the disc body (5, 9) has several parts and that wherein the vibration damping element (13) is arranged between the parts of the disc body (5, 9).

3. The friction disc (10) according to claim 2, wherein the disc body (5) has at least one hub part (14) and a friction lining carrier part (15), and wherein the vibration damping element (13) is arranged at least partly between the hub part (14) and the friction lining carrier part (15).

4. The friction disc (10) according to claim 3, wherein the hub part (14) is connected to the friction lining carrier part (15) via the vibration damping element (13).

5. The friction disc (10) according to claim 1, wherein the disc body (5, 9) has disc body segments (18), and wherein the vibration damping element (13) is arranged at least partly between the disc body segments (18).

6. The friction disc (10) according to claim 1, wherein the disc body (5, 9) has at least one recess (19), in which the vibration damping element (13) is at least partly arranged.

7. The friction disc (10) according to claim 2, wherein the vibration damping element (13) has a recess (20), wherein in addition at least a portion of the disc body (5, 9) has at least one axial projection (21), and wherein the axial projection (21) is arranged extending into the recess (20) of the vibration damping element (13).

8. The friction disc (10) according to claim 1, wherein the disc body (5, 9) has a carrier element (11, 12) and wherein the vibration damping element (13) is arranged on the carrier element (11, 12).

9. A disc set (1) comprising several friction discs (10) arranged one behind the other in an axial direction (4), wherein at least one of the friction discs (10) is embodied according to claim 1.

10. The disc set (1) according to claim 9, wherein several friction discs (10) are connected to one another via at least one vibration damping element (13).

11. The disc set according to claim 9, wherein several friction discs (10) have disc body segments (18) and wherein the disc body segments (18) of the friction discs (10), arranged one behind the other in the axial direction (4), are arranged offset in a circumferential direction.
